(19) United States
(12) Patent Application Publication
(10) Pub. No.: US 2024/0363884 A1
(43) Pub. Date: Oct. 31, 2024

(54) METHOD AND APPARATUS FOR PROVIDING ELECTRODE STRINGS AND FOR PRODUCING A MONO CELL AND A BATTERY STACK

(71) Applicant: GROB-WERKE GmbH & Co. KG, MINDELHEIM (DE)

(72) Inventors: Jürgen PAUL, LOPPENHAUSEN (DE); Alexander FRITZ, SCHIESSEN (DE); Florian SCHERER, MINDELHEIM (DE); Thomas PFITZMAIER, USTERSBACH (DE)

(21) Appl. No.: 18/648,018

(22) Filed: Apr. 26, 2024

(30) Foreign Application Priority Data
Apr. 27, 2023 (DE) 102023110842.5
Jul. 7, 2023 (EP) 23184281.6

(51) Int. Cl. H01M 10/04; B23K 26/38; B23K 37/04; B23K 101/36; H01M 4/04; H01M 50/46

(52) U.S. Cl. CPC H01M 10/0404; B23K 26/38; B23K 37/0408; H01M 4/04; H01M 10/0468; H01M 50/46; B23K 2101/36

(57) ABSTRACT

An method for providing an electrode string which has a separator web and electrode segments attached thereto at a distance from one another by: a) providing a web-shaped electrode substrate; b) picking up the web-shaped electrode substrate with a transport system having transport units individually movable along a guide track, and moving the electrode substrate in a planar manner along a cutting plane; c) cutting the web-shaped electrode substrate in the cutting plane in order to cut off electrode segments which are each arranged individually on one of the transport units; d) adjusting a distance between cut electrode segments with relative movement of the transport units in order to position the electrode segments relative to one another; e) providing a separator web; f) applying and fixing the electrode segments positioned relative to one another on the separator web.

### CROSS-REFERENCES TO RELATED APPLICATIONS

This application claims the benefit of German Patent Application Number 10 2023 110 842.5 filed on Apr. 27, 2023, and European Patent Application Number 23 184 281.6 filed on Jul. 7, 2023 the entire disclosures of which are incorporated herein by way of reference.

### FIELD OF THE INVENTION

The invention relates to an electrode string providing method for providing an electrode string which has a separator web and electrode segments attached thereto at a distance from one another. The invention also relates to a mono cell production method for producing mono cells for a battery, in which method electrode strings are provided by such an electrode string providing method. The invention further relates to a battery cell stack production method for producing a cell stack for a battery by stacking mono cells produced by the mono cell production method. The invention also relates to an electrode string providing apparatus for providing an electrode string which has a separator web and electrode segments attached to it at a distance from one another. The invention also relates to a mono cell production apparatus for producing a mono cell for a battery, which apparatus has such an electrode string providing apparatus. The invention also relates to a cell stack production apparatus for producing a battery cell stack, which apparatus comprises such a mono cell production apparatus. Finally, the invention also relates to a control system and a computer program for one of the aforementioned apparatuses.

### BACKGROUND OF THE INVENTION

The invention lies in particular in the field of automated and computer-controlled production of mono cells and battery stacks from such mono cells.

For the technological background, reference is made to the following literature:
[1] WO 2020/192 845 A1
[2] DE 10 2017 216 156 A1

Methods and apparatuses for the provision of electrode strings and for the production of mono cells and battery stacks formed from them are known from [1]. In particular, [1] describes a system for manufacturing battery cells, in which system an anode string with anodes (A) attached to a first web-shaped separator(S) and a cathode string with cathodes (K) attached to a second web-shaped separator(S) are provided as electrode strings, in which case a string composite is formed from which mono cells are separated. In contrast to the process of Z-folding battery cells, this is a continuous process. The advantage here is the higher output due to a continuous process. For this purpose, separator, anode, separator, cathode (SASK) are laminated together in the system in the following sequence. Stacking separated SASK layers creates the basis of the battery cell.

Document [2] describes a method for the production of mono cells in which the separator is first sucked onto a vacuum belt. Parallel to this process, electrodes are sucked on a drum and separated by a laser. The separated electrode is transferred to the separator and sucked through the separator onto the vacuum belt. A second separator is applied to this and then transferred to a transport system including transport units individually movable on a guide track (sometimes also called a mover system). Here, the separator web is cut and another electrode, which is provided in the same way as the first, is applied. The package is mechanically clamped and transported to the discharge point.

### SUMMARY OF THE INVENTION

The invention is based on the problem of providing improved methods and devices for the provision of electrode strings and for the production of mono cells and battery cell stacks formed therefrom in terms of cycle time and/or process control.

To solve this problem, the invention provides an electrode string providing method according to one or more embodiments disclosed herein. A mono cell production method and a battery cell stack production method which include such an electrode string providing method and devices with which such methods can be carried out as well as a correspondingly equipped control system and a computer program therefor are also disclosed herein.

According to a first aspect thereof, the invention provides an electrode string providing method for providing an electrode string which has a separator web and electrode segments attached thereto at a distance from one another, wherein the electrode string providing method comprises:
a) providing a web-shaped electrode substrate;
b) picking up the web-shaped electrode substrate by means of a transport system which has transport units individually movable along a guide track, and moving the electrode substrate along a cutting plane in a planar manner;
c) cutting the web-shaped electrode substrate in the cutting plane in order to cut off electrode segments, each of which is arranged individually on one of the transport units;
d) adjusting a distance between cut electrode segments by means of relative movement of the transport units to position the electrode segments relative to each other;
e) providing a separator web;
f) applying and fixing the electrode segments positioned relative to each other to the separator web.

Preferably, step b) comprises the step:
b1) suction of the electrode web at a pick-up point on the transport units.

Preferably, step b) comprises the step:
b2) transporting the electrode web by means of the transport units to a separation point where a flat surface for cutting is provided as a cutting plane.

Preferably, step b) comprises the step:
b3) providing transport units with interchangeable product carriers, wherein the product carriers are selected from a range of different product carriers according to the electrode format to be produced.

Preferably, step b) comprises the step:
b4) providing a horizontal cutting plane and horizontal movement along the cutting plane.

Preferably, step b) comprises the step:
b5) providing a substantially vertical cutting plane and movement along said cutting plane.

Preferably, step c) comprises the step of:
c1) cutting on a flat surface.

Preferably, step c) comprises the step:
c2) cutting along a planar cutting contour to form side edges of the electrode segment.

Preferably, step c) comprises the step:
c3) cutting by means of a guided laser beam.

Preferably, step c) comprises the step:
c4) cutting out an outgoing conductor lug on at least one side edge of the electrode segment.

Preferably, step c) comprises the step:
c5) carrying out a two-dimensional laser cut within the cutting plane. Preferably, step c) comprises the step:
c6) cleaning the electrode segment after cutting.

Preferably, step d) comprises the step:
d1) adjusting the distance by means of control software.

Preferably, step d) comprises the step:
d2) moving a transport unit carrying an electrode segment that has just been cut off away from a cutting or separating point.

Preferably, step d) comprises the step:
d3) transporting the cut-off electrode segment onwards to a device for d3) carrying out step f).

Preferably, step d) comprises the step:
d4) omitting an electrode segment at a point on the separator otherwise to be filled with an electrode segment, in order to enable the production of a half-cell, such as in particular an SAS or SKS package, in the process of producing mono cells.

Preferably, step d) comprises the step:
d5) cleaning the cut-off electrode segment and/or the transport unit.

Preferably, step f) comprises the step:
f1) positionally accurate handover of the separated electrode segments to a transport unit equipped with a heating device, in particular a vacuum heating roller.

Preferably, step d) comprises the step:
f2) targeted heating of the electrode segment.

Preferably, step d) comprises the step:
f3) lifting the electrode segments to a fixing point located above the cutting plane.

Preferably, step d) comprises the step:
f4) laminating the separator web and electrode segment between two rollers.

Preferably, step d) comprises the step:
f5) laminating the separator web and electrode segment between uncoated hard metal surfaces and/or between two hard surfaces.

Preferably, step d) comprises the step:
f6) cleaning a side of the electrode segment lifted off the transport unit.

Preferably, step d) comprises the step:
f7) by means of a lamination roller, pressing the separator web onto a vacuum heating roller or tempered roller or externally tempered vacuum roller which transports the electrode segments.

According to a further aspect thereof, the invention provides a mono cell production method for producing mono cells for a battery, wherein the mono cell comprises a respective anode segment, a cathode segment and a separator layer between the anode segment and the cathode segment and at least one separator layer on an averted surface of the anode segment and/or the cathode segment, wherein the mono cell production method comprises the steps of:
A) providing an anode string having a first separator web and anode segments fixed thereto by means of an electrode string providing method according to any one of the preceding embodiments, wherein in step a) a web-shaped anode substrate is provided,
B) providing a cathode string having a second separator web and cathode segments fixed thereto by means of the electrode string providing method according to any one of the preceding embodiments, wherein a web-shaped cathode substrate is provided in step a),
C) providing a composite string by relative positioning and joining of the anode string and the cathode string in such a way that the anode segments and cathode segments are superimposed in alignment with each other, and
D) cutting the mono cells from the composite string obtained in step C).

According to a further aspect, the invention provides a battery cell stack production method for producing a cell stack for a battery, the method comprising performing the mono cell production method according to the preceding embodiment and stacking the mono cells thus produced to form a cell stack.

According to a further aspect, the invention provides an electrode string providing apparatus for providing an electrode string which has a separator web and electrode segments attached thereto at a distance from one another, the apparatus comprising:
an electrode substrate providing device for providing a web-shaped electrode substrate;
a transport system which has transport units which can be moved individually along a guide track, the transport system being configured to pick up the web-shaped electrode substrate provided by the electrode substrate providing device and to move it along a cutting plane;
a cutting device for cutting the electrode substrate along a cutting contour extending one- or two-dimensionally in the cutting plane in order to cut electrode segments from the electrode substrate;
a separator web providing device for providing a separator web;
an applying and fixing device for applying and fixing electrode segments to the separator web which are delivered by the transport system in a manner positioned relative to one another; and a control system configured to control the electrode string providing apparatus for carrying out the electrode string providing method according to any one of the preceding embodiments.

It is preferred that the transport system has transport units with exchangeable product carriers in order to adapt the transport system to different electrode segment formats by exchanging product carriers.

It is preferred that the transport system is configured to hold the electrode substrate in the web-shaped and/or separated form on the individual transport units in a targeted manner by means of vacuum, for transporting and cutting. Other embodiments provide that the web-shaped or separated electrode substrate is alternatively or additionally held mechanically on the transport units, in particular by means of a gripper, instead of holding by vacuum.

It is preferred that the transport system has means designed as software for adjusting a distance between cut electrode segments by means of relative movement of the transport units in order to position the electrode segments relative to one another. In other embodiments, the means for adjusting the distance between cut electrode segments comprise mechanical spacers between the transport units.

Preferably, the cutting device is configured for cutting on a flat surface.

Preferably, the cutting device is configured for cutting along a flat cutting contour to form side edges of the electrode segment.

Preferably, the cutting device is configured for cutting by means of a guided laser beam.

Preferably, the cutting device is configured to cut out outgoing conductor lugs on at least one side edge of the electrode segment.

Preferably, the cutting device is configured to perform a two-dimensional laser cut within the cutting plane.

Preferably, the applying and fixing device comprises a heating device for targeted heating of the electrode segments.

Preferably, the applying and fixing device comprises a transport device for transporting and lifting the electrode segments positioned relative to each other from the transport units to a lamination point.

Preferably, the applying and fixing device comprises a vacuum heating roller or tempered roller or externally tempered vacuum roller.

Preferably, the applying and fixing device comprises a preferably uncoated laminating roller.

Preferably, the applying and fixing device comprises a pressing device.

According to a further aspect thereof, the invention provides a mono cell manufacturing apparatus comprising a first electrode string providing device according to any one of the preceding embodiments for providing an anode string provided with anode segments as electrode segments, a second electrode string providing device according to any one of the preceding embodiments for providing an anode string provided with cathode segments as electrode segments, a composite string providing device configured to connect the anode string and the cathode string to form a composite string with anode and cathode segments lying one above the other in alignment with one another, and a separating device for separating mono cells by cutting them off from the composite string.

According to a further aspect, the invention provides a cell stack production apparatus comprising a mono cell production apparatus according to the preceding embodiment and a stacking device for stacking a plurality of mono cells produced by the mono cell production apparatus to form a cell stack.

According to a further aspect, the invention provides a controller for an apparatus according to any one of the preceding embodiments, configured to control the apparatus for carrying out the method according to any one of the preceding embodiments.

In particular, the controller has a processor and a memory having a computer program loaded therein.

According to a further aspect, the invention also provides a computer program comprising instructions causing an apparatus according to any one of the preceding embodiments to perform the method according to any one of the preceding embodiments.

Preferred embodiments of the invention relate to a method for the production of mono cells. The invention is particularly applicable in the field of electromobility for the manufacture of rechargeable batteries for electrically powered vehicles. For economical production, mono cells for such batteries are to be produced in large series technology with very short cycle times in a process-reliable manner.

Preferred embodiments of the invention offer in particular one or more of the following advantages or benefits:
A production system for producing mono cells using the methods and apparatus according to advantageous embodiments of the invention can be designed in a linear form, which enables a favorable flow of materials.
The cycle times can be in the range of 0.1 s per mono cell or even less.
Electrode transfers based on measurements or image-based processes are dispensable, which means lower requirements for computing power and process times.
Lamination does not take place below the separation of the electrode tracks, so that impurities can be avoided.

In previous production systems, the following problems can occur, one or more of which are improved by advantageous embodiments of the invention:
Setup of a laser cut on a three-dimensional surface, which also moves, is complicated. In addition, the properties of the laser result in a larger heat-affected zone in the material to be cut. In preferred embodiments of the invention, the cut therefore takes place on a straight surface.
In preferred embodiments, the lamination and the cutting of the electrodes take place independently of each other, since the heat input during cutting can lead to tolerance problems.
In previous production systems, lamination is carried out by a roller with an elastic coating and is changed to “hard-hard” in preferred embodiments of the invention. The lamination temperature can be reduced due to the more effective application of pressure. By using an uncoated roller, the mechanical forces acting during lamination can also be reduced.
If the battery format to be produced is changed, the system should be convertible without great effort.
Ideally, the material is fed from a central point, but can also be advanced towards the center. A central material store should facilitate and largely automate the feeding of the coils and separator rolls into the dry clean room.
The separator usually has a certain overhang beyond the electrodes. In preferred designs, the overhang which is created by a so-called gap between the individual electrodes on the separator web is replaced by a simpler and more format-flexible solution instead of the usual mechanical creation with the aid of a slotted guide.
Ideally, the laser cut should take place at “12 o'clock” to avoid contamination of the laser. A range between “9:00 and 15:00” is intended.

In preferred embodiments of the invention, a transport system with independently movable transport units (such as a mover system with freely movable movers, as is available on the market from Beckhoff XTS, or a transport system from B&R Supertrack) is used to pick up an electrode web (almost endless) by vacuum and transport it to the separation point. Once the electrode web has been separated into sections, the flexible transport units create the freely adjustable gap between the individual electrode pieces. In this case, the separation takes place on a flat surface. For modified product sizes, other product carriers are mounted on the transport units in preferred designs; the distance can be adjusted accordingly, e.g., via the software or mechanically.

The laser cut is preferably followed by a positionally precise transfer of the separated electrodes to a vacuum heating roller; other rollers, such as tempered or externally tempered, are also possible.

In preferred embodiments, points at which the electrode webs have been joined together are not transferred, but can optionally be outfed separately. The electrodes are heated for half-cell lamination on this roller. This means that the electrodes are no longer heated during the laser cut, which means that temperature-related linear expansion no longer has a negative effect on the accuracy of the laser cut.

According to preferred embodiments of the invention, the lamination of the half-cell takes place separately from the laser cut after this transfer in a separate zone between the transport roller, such as a vacuum heating roller, and a lamination roller. Lamination can take place between two hard surfaces.

After the so-called half-cells have been laminated, in preferred embodiments of the invention, the two half-cell strings are combined to form a mono cell and also laminated together.

Preferred embodiments of the invention offer one, several or all of the following advantages:
high format flexibility
“hard-hard” lamination during half-cell production
easier gap control between the electrodes
no heat influence on the laser cut
2D laser cutting with easier calibration during start-up or format change
feeding of a half-cell into the later stacking process by omitting an electrode after separation using the flexible transport system, for example an SAS package.

### BRIEF DESCRIPTION OF THE DRAWINGS

An exemplary embodiment will be described in more detail below with reference to the attached drawings in which:

FIG. 1 is a schematic overview of a first embodiment of a cell stack production apparatus for producing a battery cell stack from a first electrode string and a second electrode string;

FIG. 2 is a schematic overview of a second embodiment of the cell stack production apparatus for producing a battery cell stack from the first electrode string and the second electrode string.

### DETAILED DESCRIPTION OF THE PREFERRED EMBODIMENTS

In the following, methods and apparatuses for providing an electrode string, for producing mono cells from a first and second electrode string provided in this way and for producing a battery cell stack from such mono cells are described with reference to the accompanying drawings.

The Figures show different embodiments of a cell stack production apparatus 20 for producing a battery cell stack 22. The cell stack production apparatus 20 includes a mono cell production apparatus 24 and a stacking device 26.

The mono cell production apparatus 24 has a first electrode string providing device 28.1, a second electrode string providing device 28.2 and a composite string providing device 30.

The respective electrode string providing device 28.1, 28.2 is used in each case to provide an electrode string 32.1, 32.2 which has a separator web 34.1, 34.2 and electrode segments 36.1, 36.2 attached thereto at a distance from one another. The structure of the first and second electrode string providing device 28.1, 28.2 is essentially the same and is described below only once using one of the first and second electrode string providing devices 28.1, 28.2 as an example.

The electrode string providing device 28.1, 28.2 has an electrode substrate providing device 38.1, 38.2, a transport system 40.1, 40.2, a cutting device 42.1, 42.2, a separator web providing device 44.1, 44.2, an applying and fixing device 46.1, 46.2 and a control unit 48.1, 48.2.

The electrode substrate providing device 38.1, 38.2 is designed to provide a web-shaped electrode substrate 50.1, 50.2. For example, the electrode substrate providing device 38.1, 38.2 has a roll holder for a supply roll 52 with the respective web-shaped electrode substrate 50.1, 50.2 and at least one drive 58 with a motor, M, which is configured to control/regulate the web tension. Furthermore, a measuring roller (not shown) is optionally provided, over which the web-shaped electrode substrate 50.1, 50.2 is passed and which records the unwinding length and/or the unwinding speed at which the web-shaped electrode substrate 50.1, 50.2 is unwound and supplied and feeds corresponding information to the controller 48.1, 48.2. Data on the delivery of the web-shaped electrode substrate 50.1, 50.2 can additionally or alternatively also be determined via the position of a dancer (not shown).

Furthermore, in the embodiments shown, the electrode substrate providing device 38.1, 38.2 has alignment elements 56, such as rollers, and possibly also further drives 58 for driving the movement of the web-shaped electrode substrate 50.1, 50.2.

The transport system 40.1, 40.2 has transport units 62 individually movable along a circumferential guide track 60. The movement of the individual transport units 62 can be controlled individually by the control unit 48.1, 48.2. The transport system 40.1, 40.2 is configured to pick up the web-shaped electrode substrate 50.1, 50.2 provided by the electrode substrate providing device 38.1, 38.2 and to move it along a cutting plane 64.

For example, the guide track 60 has a rectilinear section adjacent to a pick-up point 66, so that the surfaces of workpiece carriers of the transport units 62, on which the electrode substrate 50.1, 50.2 rests and is fixed to for example by means of vacuum or grippers (not shown), move along the cutting plane 64. Here, 65 denotes the region of the electrode fixation where the electrode substrate 50.1, 50.2 and the electrode segments separated therefrom are fixed to the transport units 62.

In some embodiments, the workpiece carriers attached to the transport units 62 run in the region of the electrode fixation 65 connected to a vacuum source (not shown) in order to fix the electrode segments 36.1, 36.2 in this region to the transport units 62. In preferred embodiments, a vacuum pump for generating a vacuum (not shown) is carried on the respective transport unit 62, which vacuum pump can be individually controlled for example via the control unit 48.1, 48.2. In further embodiments (not shown), individually controllable grippers are provided on the transport units 62.

Accordingly, in the embodiments shown, the transport system 40.1, 40.2 is configured to hold the electrode substrate 50.1, 50.2 in the web-like and/or the separated form specifically by means of vacuum (or alternatively by other means, such as grippers) on the individual transport units 62 for transporting and cutting.

In some embodiments, the transport system 40.1, 40.2 has transport units 62 with interchangeable product carriers to adapt the transport system 40.1, 40.2 to different electrode segment formats by exchanging product carriers.

As mentioned above, the movement of the transport units 62 is individually controllable. In some embodiments, the transport system 40.1, 40.2 has means implemented as software, in particular in the control system 48.1, 48.2, for adjusting a distance between cut electrode segments 36.1, 36.2 by relative movement of the transport units 62 in order to position the electrode segments 36.1, 36.2 relative to one another.

The cutting device 42.1, 42.2 is designed to cut the electrode substrate 50.1, 50.2 along a one- or two-dimensional cutting contour extending in the cutting plane 64 in order to cut the electrode segments 36.1, 36.2 from the electrode substrate 50.1, 50.2. For example, the cutting device 42.1, 42.2, as is known in principle from [1], has a cutting laser with corresponding deflection units which are controlled by the controller 48.1, 48.2 in order to direct the laser beam along the cutting contour.

The cutting device 42.1, 42.2 is configured for cutting on the flat surface. The cutting contour of the cutting device 42.1, 42.2 is designed to shape the side edges of the respective electrode segment 36.1, 36.2. In particular, outgoing conductor lugs can also be formed on at least one side edge of the electrode segment 36.1, 36.2 during cutting. This can be done by carrying out a two-dimensional laser cut within the cutting plane 64.

Since the cutting contour lies in a plane, controlling the cutting beam, including focusing, is much easier than when cutting on a curved cutting surface. Alternatively, cutting techniques other than lasers can also be used more easily due to the flat progress of the cutting curve.

The separator web providing device 44.1, 44.2 is configured to provide the separator web 34.1, 34.2. Analogous to the electrode substrate providing device 38.1, 38.2, it can for example have a supply roll 52 with the separator web 34.1, 34.2 and at least one drive 58, which is configured in particular to control/regulate the web tension, and optionally also one or more measuring rollers (not shown) or other measuring sensors, for example to detect the position of a dancer, the signals of which are also transmitted to the control unit 48.1, 48.2.

The applying and fixing device 46.1, 46.2 is designed for applying and fixing electrode segments 36.1, 36.2, which are delivered to the separator web 34.1, 34.2. in a manner positioned relative to one another by means of the transport system 40.1, 40.2,

In some embodiments, the applying and fixing device 46.1, 46.2 includes a heating device 68 for selectively heating the electrode segments 36.1, 36.2. In some embodiments, the applying and fixing device 46.1, 46.2 includes a transport device 70 for transporting and lifting the electrode segments 36.1, 36.2 positioned relative to one another from the transport units 62 to a lamination point 72.

In the embodiments shown, a vacuum heating roller 74 is provided as the transport device 70 including a heating device 68, the surface of which can be heated in a targeted manner by an integrated heater and is provided with suction openings for suction of the electrode segments 36.1, 36.2. Alternatively, a temperature-controlled roller or an externally temperature-controlled vacuum roller can also be provided.

In some embodiments, the applying and fixing device 46.1, 46.2 further comprises a preferably uncoated laminating roller 76 pressed onto the transport device 70, in particular the vacuum heating roller 74, at the pressing force of a pressing device 78 in order to laminate the electrode segments 36.1, 36.2 onto the separator web 34.1, 34.2 provided by the separator web providing device 44.1, 44.2.

In the embodiments shown, the laminating roller 76 is driven in a controlled manner by the control unit 48.1, 48.2. In some embodiments, this also drives the movements of the vacuum heating roller 74 and the separator web 34.1, 34.2. In other embodiments, the vacuum heating roller 74 is driven in a controlled manner by the control unit 48.1, 48.2. A laminating roller 76 without its own drive is also conceivable. In some embodiments, a traction unit with a drive for generating the web tension of the separator web 34.1, 34.2 is provided upstream of the laminating roller 76.

The controller 48.1, 48.2 is configured to control the electrode string providing device 28.1, 28.2 for carrying out the electrode string providing process explained below.

The controller 48.1, 48.2 has a processor 79 and a memory 81 with a computer program stored therein. The computer program contains the corresponding instructions which cause the units of the electrode string providing device 28.1, 28.2 to carry out this electrode string providing process. The respective controller 48.1, 48.2 of the first and second electrode string providing devices 28.1, 28.2 may be provided as part of an overall controller 80 of the cell stack production apparatus 20.

The electrode string providing method for providing the respective electrode string-first or second electrode string 32.1, 32.2-comprises the following steps:
a) providing the web-shaped electrode substrate 50.1, 50.2;
b) picking up the web-shaped electrode substrate 50.1, 50.2 by means of the transport system 40.1, 40.2 including the transport units 62 that can be moved individually along the guide track 60 and moving the electrode substrate 50.1, 50.2 along the cutting plane 64 in a planar manner;
c) cutting the web-shaped electrode substrate 50.1, 50.2 in the cutting plane in order to cut off electrode segments 36.1, 36.2, each of which is arranged individually on one of the transport units 62;
d) adjusting a distance between cut electrode segments 36.1, 36.2 by means of relative movement of the transport units 62 in order to position the electrode segments 36.1, 36.2 relative to one another;
e) providing the separator web 34.1, 34.2; and
f) applying and fixing the electrode segments 36.1, 36.2 positioned relative to one another to the separator web 34.1, 34.2.

In the embodiments shown, step b) is carried out in such a way that the web-shaped electrode substrate 50.1, 50.2 is sucked onto the transport units 62 respectively moving past it at the pick-up point 66 and is then transported by means of the transport units 62 to a separation point—at reference sign 3—where a flat surface for cutting is provided as cutting plane 64 on the transport units 62 by the planar movement of the transport units 62.

As already mentioned above, the transport units 62 are provided with exchangeable product carriers. To set up the cell stack production apparatus 20 for a specific format of the electrodes—anodes and/or cathodes—the product carriers are selected from a range of different product carriers according to the electrode format to be manufactured.

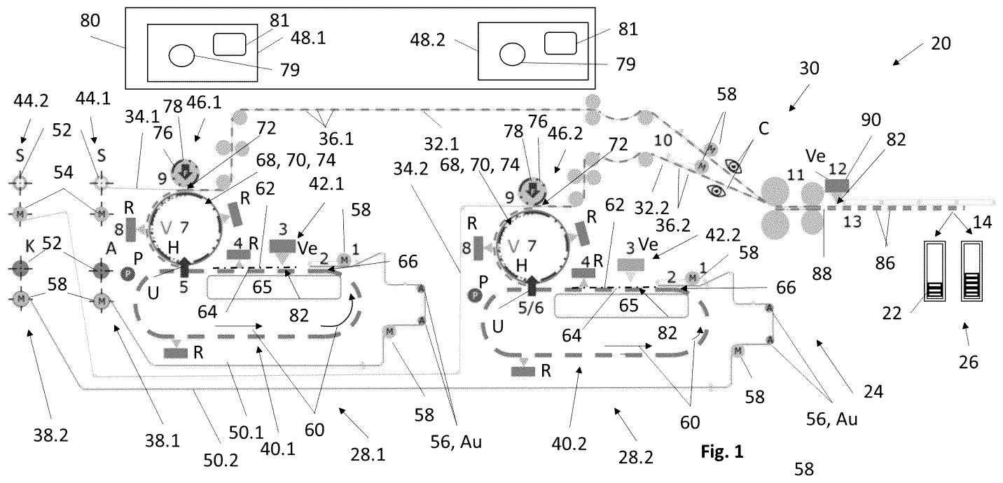

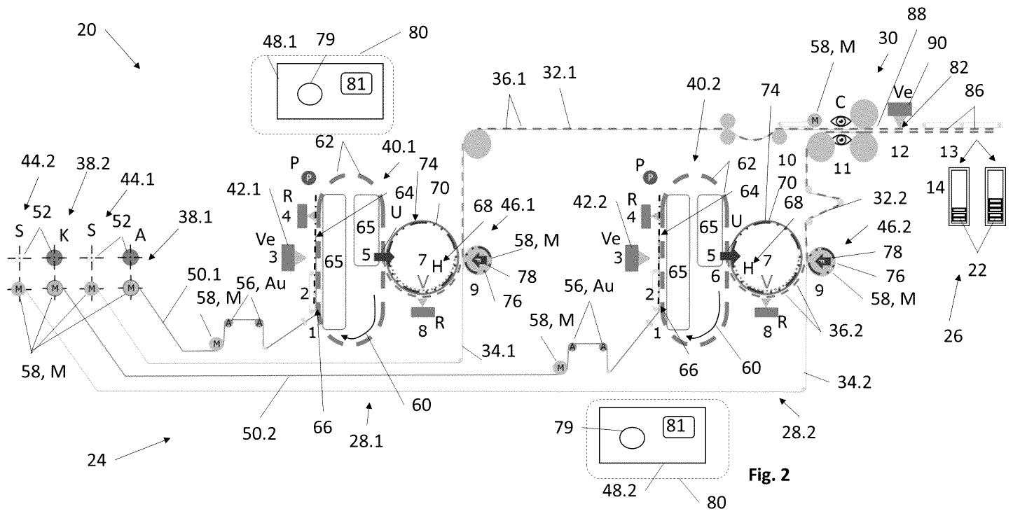

In the embodiment shown in FIG. 1, a horizontal cutting plane is provided in each case; and the electrode substrate 50.1, 50.2 is moved horizontally along the cutting plane. In the embodiment shown in FIG. 2, a substantially (+\−10%) vertical cutting plane is provided and the electrode substrate 50.1, 50.2 is moved vertically along this vertical cutting plane. Of course, also mixed forms-one of the transport systems 40.1, 40.2 transports the electrode substrate horizontally, the other vertically—or also inclined cutting planes are possible.

In the embodiments shown, cutting takes place on a flat surface on the product carriers. Cutting takes place along a flat cutting contour which is designed at least for forming side edges of the electrode segments 36.1, 36.2 or also for forming outgoing conductor lugs or the like. Cutting is carried out in particular by means of at least one guided laser beam which is moved along the cutting contour, although other cutting techniques (e.g., using knives, punching) are of course also possible. Thus, a two-dimensional laser cut is preferably performed in the cutting plane 64. Preferably, the respective electrode segment 36.1, 36.2 is cleaned after cutting.

The distance between the cut electrode segments is preferably set to the distance between the transport units 62 after cutting by means of the control software. For this purpose, in particular the transport unit 62 carrying an electrode segment that has just been cut off is moved away from the separation point 82 and moved at a suitable distance to the applying and fixing device 46.1, 46.2, where step f) is carried out. In some embodiments, an electrode segment 36.1, 36.2 can be omitted at a location on the separator that would otherwise be occupied by electrode segments, for example by holding back the transport units 62, if necessary, in order to enable the production of a half-cell such as in particular an SAS or SKS package in the process of producing mono cells. In some embodiments, the cut electrode segment and/or the transport unit is cleaned.

In some embodiments, step f) is carried out with at least one or more of the following sub-steps:
f1) transferring the separated electrode segments 36.1, 36.2 to the transport unit 70 having the heating device 68, in particular the vacuum heating roller 74, in an exactly positioned manner;
f2) targeted heating of the electrode segments 36.1, 36.2 for lamination;
f3) lifting the electrode segments 36.1, 36.2 to a fixing point-lamination point 72-located above the cutting plane 64 and thus outside the region that could be contaminated by cutting particles;
f4) laminating the separator web 34.1, 34.2 and electrode segment 36.1, 36.2 between two rollers 74, 76;
f5) laminating the separator web 34.1, 34.2 and electrode segment 36.1, 36.2 between uncoated hard metal surfaces and/or between two hard surfaces (e.g. on rollers 74, 76);
f6) cleaning a side of the electrode segment 36.1, 36.2 that is lifted from the transport unit 62;
f7) pressing the separator web onto the vacuum heating roller 74 or tempered roller or externally tempered vacuum roller, which transports the electrode segments 36.1, 36.2, by means of the lamination roller 76.

The electrode string providing method is carried out in particular in the course of producing mono cells 86 for a battery, wherein the mono cell 86 has an anode segment (example for a first electrode segment 36.1), a cathode segment (example for a second electrode segment 36.2) and a separator layer between the anode segment and the cathode segment as well as at least one separator layer on an opposite surface of the anode segment and/or the cathode segment (layer structure SASK or SKSA). The mono cell production method comprises in particular the following steps:
A) providing an anode string as a first electrode string 32.1 (half-cell string) with the first separator web S, 34.1 and first electrode segments 36.1 fixed thereto in the form of anode segments by means of the electrode string providing method, a web-shaped anode substrate A being provided in step a),
B) providing a cathode string as a second electrode string 32.2 (half-cell string) with the second separator web S, 34.2 and second electrode segments 36.2 fixed thereto in the form of cathode segments by means of the electrode string providing method, a web-shaped cathode substrate K being provided in step a),
C) providing a composite string 88 (mono cell string) by relative positioning and joining of the anode string and the cathode string so that the anode segments and cathode segments lie on top of each other in alignment, and
D) cutting off the mono cells 86 from the composite string 88 obtained in step C).

In the embodiments of the composite string providing device 30 shown, the first electrode string providing device 28.1 thus serves to provide an anode string provided with anode segments as first electrode segments 36.1, and the second electrode string providing device 28.2 serves to provide an anode string provided with cathode segments as second electrode segments 36.2. The composite string providing device 30 is configured to connect the anode string and the cathode string to form the composite string 88 with anode and cathode segments superimposed in alignment with each other, and a separating device 90 is provided for separating mono cells 86 by cutting them from the composite string 88.

In the cell stack production apparatus, in addition to this mono cell production apparatus 24, the stacking device 26 is provided which is designed for stacking a plurality of mono cells produced by the mono cell production apparatus 24 to form a cell stack.

Specific preferred embodiments of the cell stack production method are apparent from FIGS. 1 and 2. The following method steps are shown:
1 feeding electrodes and separators as web material into the cutting and laminating process
2 mounting the web on a transport system with flexibly movable carriers for the separated electrodes
3 separating the electrode webs for both the anode and the cathode
4 optional cleaning of the electrodes
5 transfer of the electrodes to the vacuum roller
6 if required, an electrode can optionally be omitted for the provision of a half-cell, for example an SAS package
7 heating the electrodes
8 optional cleaning of the electrodes
9 lamination of the half-cells to form two half-cell strings
10 joining the half-cell strings
11 lamination of the two half-cell strings to form a mono-cell string
12 separating the mono cells
13 transferring the mono cells to a conveyor belt for further processing
14 stacking the mono cells to form a battery cell stack

The symbols used in the drawings mean:
U transfer lamination
R cleaning
Ve separation
C control
M drive
Au alignment
P (paper winder/trash can autosplice)
H heating
V vacuum
S separator
K cathode (substrate)
A anode (substrate)

In contrast to the embodiment shown in FIG. 1, the transport systems 40.1 and 40.2 are rotated by 90° in the embodiment shown in FIG. 2. This results in simplified web guidance and simplified adjustment of the contact pressure of the lamination roller at the lamination point 72. However, the longer transport path of the electrode via the curve on the transport system 40.1, 40.2 and a possible drop of any waste products that may occur during the separation of the individual electrodes are disadvantageous compared to the variant in FIG. 1.

The systems and devices described herein may include a controller or a computing device comprising a processing and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

1 feeding electrodes and separators as web material into the cutting and laminating process
2 mounting the web on a transport system with flexibly movable carriers for the separated electrodes
3 separation of the electrode webs for both the anode and the cathode
4 optional cleaning of the electrodes
5 transfer of the electrodes to the vacuum roller
6 if required, an electrode can optionally be omitted to provide a half-cell, for example for an SAS package
7 heating the electrodes
8 optional cleaning of the electrodes
9 lamination of the half-cells to form two half-cell strings
10 joining the half-cell strings
11 lamination of the two half-cell strings to form a mono cell string
12 separating the mono cells
13 transferring the mono cells to a conveyor belt for further processing
14 stacking the mono cells to form a battery cell stack
20 cell stack production apparatus
22 battery cell stack
24 mono cell production device
26 stacking device
28.1 first electrode string providing apparatus
28.2 second electrode string providing apparatus
30 composite string providing apparatus
32.1 first electrode string
32.2 second electrode string
34.1 first separator web
34.2 second separator web
36.1 first electrode segment
36.2 second electrode segment
38.1 first electrode substrate providing device
38.2 second electrode substrate providing device
40.1 first transport system
40.2 second transport system
42.1 first cutting device
42.2 second cutting device
44.1 first separator web providing device
44.2 second separator web providing device
46.1 first applying and fixing device
46.2 second applying and fixing device
48.1 first control unit
48.2 second control unit
50.1 first web-shaped electrode substrate
50.2 first web-shaped electrode substrate
52 supply roll
56 alignment element
58 drive
60 guide track
62 transport unit
64 cutting plane
65 electrode fixation
66 pick-up point
68 heating device
70 transport unit
72 laminating point
74 vacuum heating roller
76 laminating roller
78 pressing device
79 processor
80 overall control
81 memory
82 separation point
86 mono cell
88 composite string
90 separating device
U transfer lamination
R cleaning
Ve separation
C control
M drive
Au alignment
P (paper winder/trash can autosplice)
H heating
V vacuum
S separator
K cathode substrate
A anode substrate

1. A method for providing an electrode string which has a separator web and electrode segments attached thereto at a distance from one another, the method comprising:
a) providing a web-shaped electrode substrate;
b) picking up the web-shaped electrode substrate with a transport system which has transport units individually movable along a guide track, and moving the electrode substrate in a planar manner along a cutting plane;
c) cutting the web-shaped electrode substrate in the cutting plane in order to cut off electrode segments which are each arranged individually on one of the transport units;
d) adjusting a distance between cut electrode segments with a relative movement of the transport units in order to position the electrode segments relative to one another;
e) providing a separator web; and,
f) applying and fixing the electrode segments positioned relative to each other to the separator web.

2. The method according to claim 1, wherein step b) comprises at least one or more of the steps:
b1) suction of the web-shaped electrode substrate at a pick-up point on the transport units;
b2) transporting the web-shaped electrode substrate by means of the transport units to a separation point where a flat surface for cutting is provided as a cutting plane;
b3) providing transport units with exchangeable product carriers, the exchangeable product carriers being selected from a range of different exchangeable product carriers according to an electrode format to be produced;
b4) providing a horizontal cutting plane and horizontal movement along horizontal the cutting plane; and
b5) providing a substantially vertical cutting plane and movement along the substantially vertical cutting plane.

3. The method according to claim 1, wherein step c) comprises at least one or more of the steps:
c1) cutting on a flat surface;
c2) cutting along a flat cutting contour to shape side edges of each electrode segment;
c3) cutting with a guided laser beam;
c4) cutting out outgoing conductor lugs on at least one side edge of each electrode segment;
c5) carrying out a two-dimensional laser cut within the cutting plane; and,
c6) cleaning each electrode segment after cutting.

4. The method according to claim 1, wherein step d) comprises at least one or more of the steps:
d1) adjusting the distance with control software;
d2) moving a transport unit, which carries an electrode segment that has just been cut off, away from a cutting or separating point;
d3) further transporting the cut-off electrode segment to a device for carrying out step f);
d4) omitting an electrode segment at a location on the separator web which is otherwise to be occupied by an electrode segment, in order to enable production of a half-cell; and
d5) cleaning the cut-off electrode segment, or the transport unit, or both.

5. The method according to claim 1, wherein step f) comprises at least one or more of the steps:
f1) transferring the separated electrode segments with positional accuracy to a transport device having a heating device;
f2) targeted heating of the electrode segment;
f3) lifting the electrode segments to a fixing point located above the cutting edge;
f4) laminating the separator web and electrode segment between two rollers;
f5) laminating the separator web and electrode segment between uncoated hard metal surfaces, between two hard surfaces, or both;
f6) cleaning a side of the electrode segment lifted off the transport unit;
f7) pressing the separator web onto a vacuum heating roller or tempered roller or externally tempered vacuum roller, which transports the electrode segments, with a laminating roller.

6. A method for producing mono cells for a battery, wherein the mono cell comprises an anode segment, a cathode segment and a separator layer between the anode segment and the cathode segment and at least one separator layer on an averted surface of the anode segment, or the cathode segment, or both, the method comprising the steps of:
A) providing an anode string with a first separator web and anode segments fixed thereto, wherein a web-shaped anode substrate is provided in step a),
B) providing a cathode string with a second separator web and cathode segments fixed thereto, wherein both the anode string of step A) and the cathode string of step B) are provided according to the method of claim 1, wherein a web-shaped anode substrate is provided in step a) for the anode string, and wherein a web-shaped cathode substrate is provided in step a) for the cathode string,
C) providing a composite string by relatively positioning and joining the anode string and the cathode string so that the anode segments and cathode segments lie on top of each other in alignment, and
D) cutting mono cells from the composite string obtained in step C).

7. The method of claim 6 further comprising:
stacking the mono cells to form a cell stack.

8. An apparatus for providing an electrode string which has a separator web and electrode segments attached thereto at a distance from one another, the apparatus comprising:
an electrode substrate providing device for providing a web-shaped electrode substrate;
a transport system comprising transport units configured to be moved individually along a guide track, the transport system configured to pick up the web-shaped electrode substrate provided by the electrode substrate providing device and to move the web-shaped electrode substrate along a cutting plane;
a cutting device for cutting the electrode substrate along a cutting contour extending one- or two-dimensionally in the cutting plane in order to cut electrode segments from the electrode substrate;
a separator web providing device for providing a separator web;
an applying and fixing device for applying and fixing electrode segments delivered by the transport system to the separator web in a manner positioned relative to one another; and
a controller configured to control the apparatus.

9. The apparatus according to claim 8, wherein the transport system comprises transport units with exchangeable product carriers in order to adapt the transport system to different electrode segment formats by exchanging product carriers; or
wherein the transport system is configured to hold the electrode substrate in a web-shaped form, or separated form, or both on the individual transport units in a targeted manner by means of vacuum, for transporting and cutting; or
wherein the transport system comprises software for adjusting a distance between cut electrode segments with a relative movement of the transport units in order to position the electrode segments relative to one another; or
any combination thereof.

10. The apparatus according to claim 8, wherein the cutting device is configured for:
cutting on a flat surface; or
cutting along a flat cutting contour to shape side edges of the electrode segment; or
cutting with a guided laser beam; or
cutting out outgoing conductor lugs on at least one side edge of the electrode segment; or
carrying out a two-dimensional laser cut within the cutting plane; or
a combination thereof.

11. The apparatus according to claim 8, wherein the applying and fixing device comprises at least one or more of the following units:
a heating device for selectively heating the electrode segments;
a transport device for transporting and lifting the electrode segments, which are positioned relative to one another, from the transport units to a laminating point;
a vacuum heating roller or tempered roller or externally tempered vacuum roller;
an uncoated laminating roller;
a pressing device.

12. An apparatus comprising:
a first electrode string providing device for providing an anode string provided with anode segments as electrode segments,
a second electrode string providing device for providing an anode string provided with cathode segments as electrode segments, wherein both of the first electrode string providing device and the second electrode string providing device comprise the apparatus of claim 8,
a composite string providing device configured to connect the anode string and the cathode string to form a composite string with anode and cathode segments superimposed in alignment with each other, and
a separating device for separating mono cells by cutting the mono cells from the composite string.

13. An apparatus comprising:
the mono cell production apparatus according to claim 12, and
a stacking device for stacking a plurality of mono cells produced by the mono cell production apparatus to form a cell stack.

14. The apparatus of claim 13 further comprising:
a controller.

15. A non-transitory computer readable medium comprising a computer program comprising instructions configured to perform the method according to claim 1.
